(19) United States
(12) Patent Application Publication
(10) Pub. No.: US 2013/0003952 A1
(43) Pub. Date: Jan. 3, 2013

(54) SYSTEMS AND METHODS OF THIRD PARTY CALL CONTROL AND CONTENT INSERTION

(75) Inventors: Robert Clark Whitten, Kennesaw, GA (US); Brandon Hall Goode, Canton, GA (US)

(73) Assignee: COX COMMUNICATIONS, INC., Atlanta, GA (US)

(21) Appl. No.: 13/171,342

(22) Filed: Jun. 28, 2011

(51) Int. Cl. H04M 11/00; H04M 3/42

(52) U.S. Cl. 379/93.17; 379/201.01

(57) ABSTRACT

Systems and methods for providing third party call services with the delivery of content to a calling party communication device are described herein. The systems may comprise a website server and telco gateway configured to enable a calling party to initiate a communication session between a calling party communication device and a called party communication device via a web page of a website hosted by the website server. During establishment of the communication session, the telco gateway determines what content to deliver to the calling party communication device and delivers such content to the calling party communication device while waiting to receive an answer of a call initiated to the called party communication device. The system may deliver different forms of content to a calling party communication device based on a variety of considerations.

### TECHNICAL FIELD

The present disclosure is generally related to communication systems and, more particularly, is related to content insertion by a third party.

### BACKGROUND

Third party call control applications enable a computer or similar device to establish a voice communication session between the computer or device's user (the “calling party”) and a called party in response to input information or a selection from the user. Generally, the voice communication session comprises a telephone call established between a communication device of the calling party and a communication device of the called party. The communication devices may comprise corded and cordless telephones, satellite telephones, personal communication devices such as cellular telephones, BlackBerry® devices, smart phones and the like, personal digital assistants, bi-directional audio enabled computers commonly referred to as portable computers, laptop computers, notebook computers, and desktop computers, and other similar or dissimilar devices that enable bi-directional voice communication.

Such third party call control applications include server-side initiated applications and client-side initiated applications which may receive and store identifiers for the calling and/or called party's communication devices or that may prompt for the input of such identifiers from the user. For example, a third party control application such as Facebook® may store previously received profile information for Facebook® members, including identifiers (commonly referred to as telephone numbers) for one or more of the members' communication devices. Once a first member has logged into Facebook®, the application can retrieve identifier(s) for the first member's communication device(s). Upon receiving the selection of a second member from a list of other Facebook® members, the third party control application can retrieve identifier(s) for the second member's communication device(s). Then, after receiving the selection of an option from the first member (the “calling party”) to establish a communication session with a particular communication device of the second member (the “called party”), the third party control application uses the identifiers of the members' communication devices to establish a voice communication session between the communication devices.

During the establishment of the voice communication session, the calling party's communication device receives an alert notification from the communication network providing communication service to the called party's communication device. The alert notification informs the calling party that establishment of the communication session is being attempted and that the communication network is waiting on the called party to answer the communication device being called. Generally, the alert notification comprises a ring back tone, but may comprise ring back music. The average time period that an alert notification is produced typically comprises twenty to thirty seconds. Unfortunately, this time is essentially wasted while the calling party waits on the called party to answer the called communication device.

Therefore, there is a need for systems and/or methods that enable a computer or similar device to establish a voice communication session between a calling party's communication device and a called party's communication device while making use of the time period during which the calling party waits on the called party to answer his/her communication device, and that may address other technological and/or business issues associated with current systems and/or methods.

### SUMMARY

Example embodiments of the present disclosure provide systems of systems and methods of third party call control and content insertion. Briefly described, in architecture, one example embodiment of the system, among others, can be implemented as follows: a device configured for establishing a call from a calling party communication device to a called party communication device in response to receiving direction via a website to establish a communication session involving the calling party communication device and the called party communication device, said device being further configured to communicate content to the calling party communication device while waiting on the called party communication device to answer.

Embodiments of the present disclosure can also be viewed as providing methods for systems and methods of third party call control and content insertion. In this regard, one embodiment of such a method, among others, can be broadly summarized by the following steps: receiving input indicating a calling party's desire to establish a communication session with a called party between a calling party communication device and a called party communication device; establishing a call with the calling party communication device; initiating a call to the called party communication device; communicating content to the calling party communication device while waiting on an answer of the call to the called party communication device; and connecting the call with the calling party communication device and the call to the called party communication device after answer of the call to the called party communication device.

### BRIEF DESCRIPTION OF THE DRAWINGS

FIG. 1 displays a block diagram representation of an example embodiment of a third party call control and content insertion system and environment.

FIG. 2 displays a block diagram representation of an example embodiment of a website server of the third party call control and content insertion system of FIG. 1.

FIG. 3 displays a block diagram representation of an example embodiment of a telco gateway of the third party call control and content insertion system in accordance with the example embodiment of FIG. 1.

FIGS. 4A and 4B display a flowchart representation of an example embodiment of a method of operation of the third party call control and content insertion system in accordance with the example embodiment of FIG. 1.

FIG. 5 displays a block diagram representation of an example embodiment of a third party call control and content insertion system and environment in accordance with an alternative embodiment.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

Broadly described, the present invention comprises a system, including apparatuses and methods, for providing third party call services with the delivery of content to a calling party communication device. According to the example embodiments described herein, a website server and telco gateway are configured to enable a calling party to initiate a communication session between a calling party communication device and a called party communication device via a web page of a website hosted by the website server. During establishment of the communication session, the telco gateway may determine what content to deliver to the calling party communication device and delivers such content to the calling party communication device while calling party waits to receive an answer of a call initiated to the called party communication device.

Advantageously, the system, apparatuses, and methods enable a telecommunication service provider or other party to provide third party call services with the delivery of different forms of content to calling party communication devices based on a variety of considerations, including, but not limited to, the type and location of a calling party communication device, type and location of the called party, demographic information about the calling or called parties, and profile information established by the calling or called parties. Also, by virtue of the system's ability to deliver different forms of content to different types of calling party communication devices, the system may deliver, for example and not limitation, audio information in the form of advertisements, music, news, traffic alerts, weather alerts, and/or information pertaining to current events to calling party communication devices that are capable of receiving content comprising only audio information. For those calling party communication devices that are capable of receiving content comprising audio and video information, the system may deliver, without limitation, video advertisements, commercials and other programming originally made or aired on television, music, music videos, news, pictures, images, picture or image slide shows, traffic alerts, weather alerts, and/or information pertaining to current events.

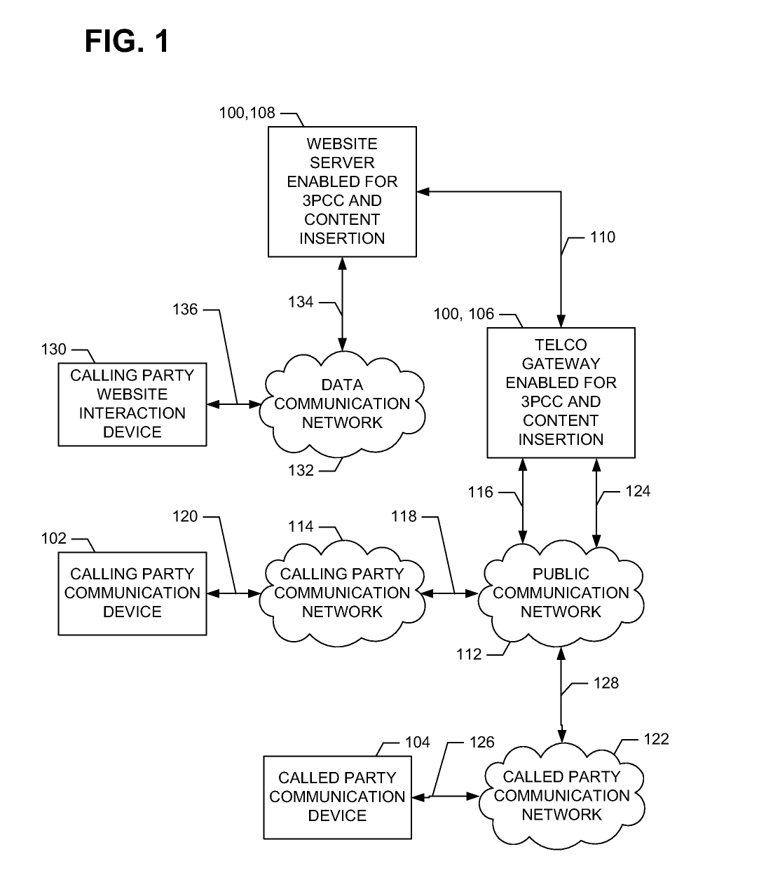

Referring now to the drawings in which like numerals represent like elements or steps throughout the several views, FIG. 1 displays a block diagram representation of an example embodiment of a third party call control and content insertion system 100. Third party call control (“3PCC”) and content insertion system 100 is, generally, used and implemented by a telecommunication service provider (such as, but not limited to, a cable-based telecommunication service provider) to provide content during the establishment of a communication session between calling party communication device 102 and called party communication device 104 that may be initiated on the server side by a computer software application in response to input(s) from the calling party. Third party call control and content insertion system 100 (also referred to herein as the “system 100”) provides the content to calling party communication device 102 during the period of time that system 100 and calling party are waiting on the called party to answer his/her communication device 104. In accordance with the example embodiments described herein, the calling and called party communication devices 102, 104 generally comprise devices enabled to provide the bi-directional communication of audio information during a communication session between the calling and called party communication devices 102, 104. The content generally comprises, but is not limited to, audio information in the form of advertisements, music, news, traffic alerts, weather alerts, and/or information pertaining to current events. However, according to other example embodiments now or in the future, the calling and called party communication devices 102, 104 may comprise devices enabled to provide the bi-directional communication of audio and/or video information during a communication session between the calling and called party communication devices 102, 104. The content may comprise, for example and not limitation, advertisements, music, music videos, news, pictures, images, picture or image slide shows, traffic alerts, weather alerts, and/or information pertaining to current events, each of which may include video and/or audio information.

As illustrated in FIG. 1, an example embodiment of system 100 comprises telco gateway 106 and website server computer system 108 (also referred to herein as a “website server 108”). Telco gateway 106 and website server 108 are connected for bi-directional data communication via data communication link 110. Telco gateway 106 is, generally, owned and/or operated by a telecommunication service provider, while website server 108 may be owned and/or operated by a telecommunication service provider or by a party other than a telecommunication service provider.

Telco gateway 106, described in more detail below, is adapted with hardware and software appropriate to establish a communication session between telco gateway 106, calling party communication device 102, and called party communication device 104 when provided with identifiers uniquely identifying communication devices 102, 104. Telco gateway 106, is also adapted with hardware and software appropriate to store content and/or links to content, to determine and identify which content should be provided to calling party communication device 102, to initiate playback of the identified content to calling party communication device 102, to ascertain when called party communication device 104 answers a call placed thereto by telco gateway 106, and to stop playback of the content after ascertaining that called party communication device 104 has answered such call or after the passage of a pre-determined period of time often referred to as a “time-out period”.

Telco gateway 106 is connected to calling party communication device 102 for the communication of information, data, and/or signals via public communication network 112, calling party communication network 114, and bi-directional communication links 116, 118, 120. Public communication network 112, according to an example embodiment, comprises the bi-directional communication network commonly referred to as the “public switched telephone network”, but may include other communication networks appropriate or necessary to implement and/or operate system 100 as described herein. Calling party communication network 114 generally comprises a bi-directional communication network owned and/or operated by the telecommunication services provider that provides telecommunication services to the calling party and calling party communication device 102. It should be appreciated and understood that public communication network 112, calling party communication network 114, and bi-directional communication links 116, 118, 120 may each include and utilize, as appropriate or necessary, infrastructure for communicating information, data, and/or signals via wired and/or wireless communication paths in electrical, optical, and/or electromagnetic form, as the case may be.

Additionally, telco gateway 106 is connected to called party communication device 104 for the communication of information, data, and/or signals therewith via the public communication network 112, called party communication network 122, and bi-directional communication links 124, 126, 128. Typically, called party communication network 122 comprises a bi-directional communication network owned and/or operated by the telecommunication services provider that provides telecommunication services to the called party and called party communication device 104. Similar to calling party communication network 114 and bi-directional communication links 116, 118, 120, it should be appreciated and understood that the called party communication network 122 and bi-directional communication links 124, 126, 128 may each include and utilize, as appropriate or necessary, infrastructure for communicating information, data, and/or signals via wired and/or wireless communication paths in electrical, optical, and/or electromagnetic form, as the case may be.

Website server 108, also described in more detail below, is configured to host a website and to provide a calling party with access to and interaction with the website via calling party website interaction device 130, data communication network 132, and bi-directional data communication links 134, 136. For example and not limitation, the website might comprise a social networking website such as Facebook® or MySpace®, or might comprise a website of a telecommunication service provider. Regardless of the nature of the website, website server 108 is configured with appropriate hardware and website application 166 to implement the website, which when executed by the hardware, receives and processes input(s) received from the calling party via calling party website interaction device 130 and causes the display of one or more web pages and appropriate information to the calling party via calling party website interaction device 130 in response to such received input(s). Through such interaction and operation, website server 108 provides services to and interaction with the calling party via the website, whether social networking services, shopping services, account management services, or other form of services.

Website application 166 is configured, in response to input(s) received from a calling party indicating the calling party's desire to establish a communication session with a called party, to collect identifiers that uniquely and respectively identify calling party communication device 102 and called party communication device 104 to be used in the communication session. Website application 166 may also be configured to cause the initiation of the communication session between telco gateway 106 and communication devices 102, 104 by communicating the identifiers to control engine 168 of system 100 that resides on website server 108. Control engine 168 comprises software executable by website server 108 that is adapted to receive such identifiers from website application 166 and to instruct telco gateway 106 to create the communication session with calling and called party communication devices 102, 104.

According to the example embodiments described herein, calling party website interaction device 130 comprises a data processing device adapted to access and interact with data communication network 132 and a website hosted by website server 108. Thus, calling party website interaction device 130 includes, but is not limited to, an appropriately configured computer, personal communication device, personal digital assistant, smart phone, or other similar device available now or in the future. Also according to the example embodiments, data communication network 132 comprises, without limitation, the data communication network commonly referred to as the “Internet” and bi-directional data communication links 134, 136 comprise, without limitation, infrastructure of one or more telecommunication service provider(s) appropriate for bi-directional data communications with the Internet. Such infrastructure may communicate information, data, and/or signals via wired and/or wireless communication paths in electrical, optical, and/or electromagnetic form, as the case may be. It should be noted that calling party website interaction device 130 and calling party communication device 102 may comprise a single device having the capabilities and/or functionality described herein.

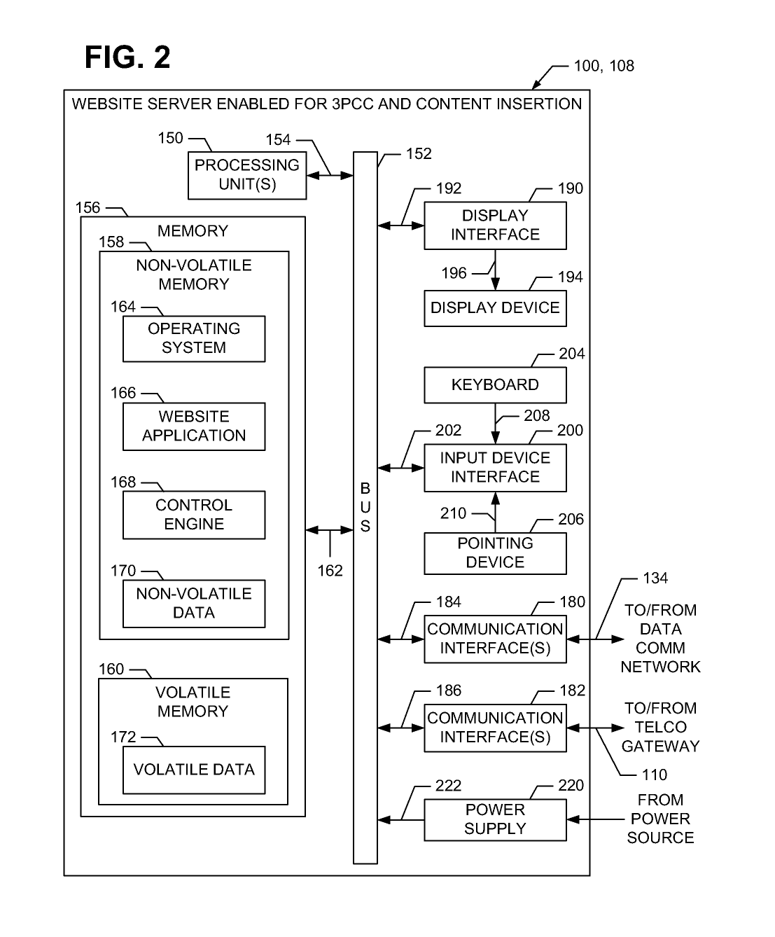

FIG. 2 displays a block diagram representation of an example embodiment of a website server 108 of third party call control and content insertion system 100. Website server 108 comprises one or more processing unit(s) 150 adapted to execute computer software instructions of operating system 164 and other computer software as required to provide the functionality described herein. Processing unit(s) 150 may include, but not be limited to, microprocessors or other similar components. Each processing unit 150 is connected to bus 152 by bi-directional communication paths 154 for the bi-directional communication of address, data and control signals with the bus 152. Bus 152 includes a plurality of address, data and control electrical signal paths as appropriate to communicate address, data and control electrical signals between the various components of website server 108.

Website server 108 further comprises memory 156, including non-volatile memory 158 and volatile memory 160. Memory 156 is communicatively connected to bus 152 for the bi-directional communication of computer software instructions, addresses, data and control signals with bus 152 and other components connected to bus 152, through one or more bi-directional communication paths 162. Non-volatile memory 158 generally stores information and/or data that will not be lost when electrical power to non-volatile memory 158 is removed. Examples of non-volatile memory include, without limitation, flash random access memory devices, battery backed up random access devices, read only memory devices, programmable read only memory devices, electrically programmable read only memory devices, magnetic disks, optical disks, and other similar or non-similar devices available now or in the future. Volatile memory 160 typically stores information and/or data for a temporary period of time, as such information and/or data that will be lost when electrical power is no longer supplied to volatile memory 160. Examples of volatile memory include, but are not limited to, non-battery backed up random access memory devices.

In accordance with the example embodiments, non-volatile memory 158 stores a plurality of computer software instructions of operating system 164 that, when delivered to and executed by processing unit 150, enable processing unit 150 and other website server components to perform various actions and provide the basic functionality necessary to implement the methods described herein. Non-volatile memory 158 also stores computer software instructions of website application 166, which when communicated to and executed by processing unit 150, causes website server 108 to operate according to website application 166, thereby implementing the website and enabling website server 108 to initiate the establishment of a communication session between telco gateway 106, calling party communication device 102, and called party communication device 104 with content being played back to calling party communication device 102 while waiting on an answer of called party communication device 104. Non-volatile memory 158 additionally stores computer software instructions of the system's control engine 168 that cause website server 108, upon the communication to and execution of such instructions by processing unit 150, to direct telco gateway 106 to start the communication session between telco gateway 106, calling party communication device 102, and called party communication device 104. In addition, non-volatile memory 158 stores non-volatile data 170 that may include pre-provided identifiers for calling and called party communication devices 102, 104 and/or that is used by processing unit 150 during execution of operating system 164, website application 166, and control engine 168.

More particularly, when executed by processing unit 150, website application 166 causes website server 108 to provide an option on a web page accessed and displayed by calling party website interaction device 130 that, when selected by the calling party, causes website application 166 to direct control engine 168 to start a communication session. The option may comprise, but not be limited to, a button or icon that may be selected by the calling party through use of a pointing device of calling party website interaction device 130. Upon receiving selection of the option by the calling party and acting under the control of website application 166, website server 108 obtains and collects respective identifiers for calling and called party communication devices 102, 104 such as, for example and not limitation, telephone numbers, media access control (“MAC”) addresses, or other similar unique identifiers. Such identifiers may be obtained from profile or other data previously stored by website server 108 in non-volatile memory 158 and associated with the calling and/or called party, may be obtained by request from the calling party, or may be obtained from another data source by communications with such data source. After obtaining the identifiers and continuing to act under the control of website application 166, website server 108 initiates execution of control engine 168 and provides the identifiers to control engine 168 by generating and sending an appropriate message to control engine 168.

Once execution of control engine 168 by processing unit 150 begins, control engine 168 causes website server 108 to receive the message produced and sent by website application 166 including the identifiers for calling and called party communication devices 102, 104. After receiving the message, further execution of control engine 168 causes website server 108 to generate and send an appropriate message, together with the identifiers of calling and called party communication devices 102, 104, to telco gateway 106 directing telco gateway 106 to establish a communication session between telco gateway 106, identified calling party communication device 102, and identified called party communication device 104.

Volatile memory 160 stores volatile data 172 that is created and/or used by operating system 164, website application 166, or control engine 168 during execution. Volatile data 172 may include, for example and not limitation: identifiers for calling and called party communication devices 102, 104 received from a calling party via his/her website interaction device 130 or retrieved from non-volatile memory 158; messages generated by website application 166 or control engine 168; and, intermediate data produced by execution of operating system 164, website application 166, and/or control engine 168.

Website server 108 also comprises communication interfaces 180, 182 that connect to bus 152 via respective communication paths 184, 186 for the bi-directional communication of address, data and control signals therebetween. Communication interface 180 connects website server 108 for the bi-directional communication of messages, information, data, and/or signals with calling party website interaction devices 130 via communication links 134, data communication network 132, and communication links 136. Communication interface 182 connects website server 108 to telco gateway 106 via communication link 110 for the bi-directional communication of messages, information, data, and/or signals therebetween.

In accordance with at least one example embodiment, website server 108 may additionally comprise display interface 190 connected to bus 152 via communication path 192 for the bi-directional communication of addresses, data and/or control signals with bus 152 and various components connected to bus 152. Display device 194 may be connected to display interface 190 via communication path 196 for the receipt and display of video or image signals received from display interface 190. Similarly, input device interface 200 is connected to bus 152 via communication path 202 for the bi-directional communication of addresses, data and/or control signals with bus 152 and various components connected to bus 152. Keyboard 204 and pointing device 206 are, respectively, connected to input device interface 200 via respective communication paths 208, 210 for the receipt of input from an administrator of website server 108 and for the communication of data representative of such input to input device interface 200. Power supply 220 is connected to bus 152 via electrical signal path 222 to supply electrical energy to bus 152 and components connected to bus 152 that is necessary for their operation.

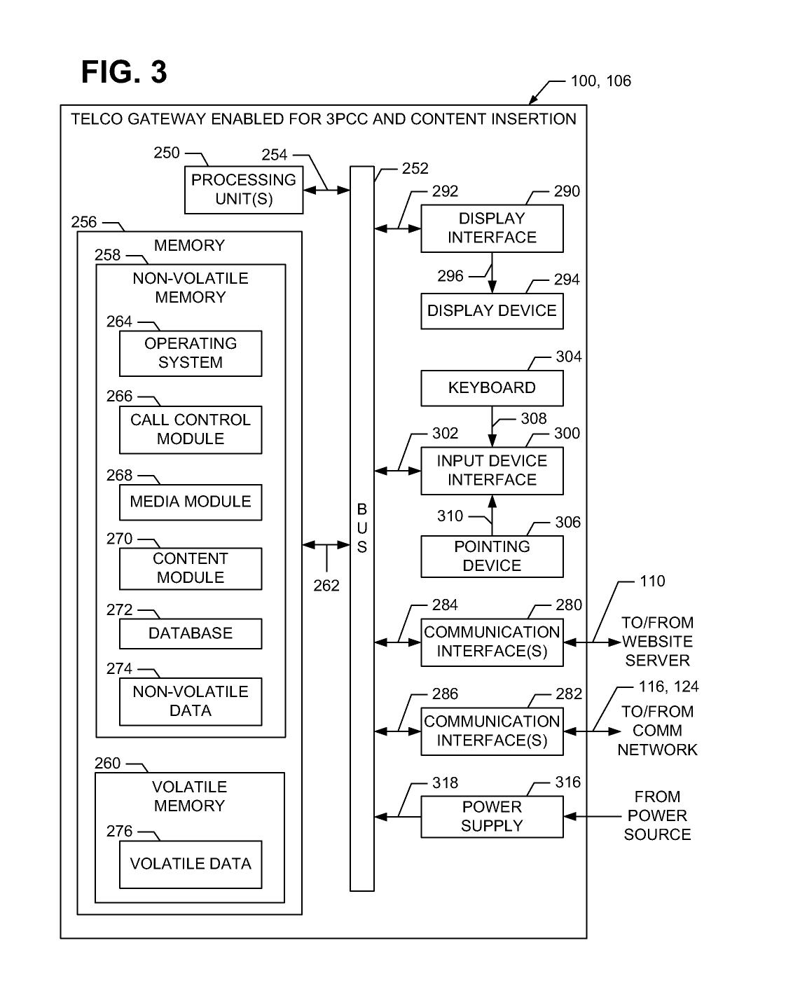

FIG. 3 displays a block diagram representation of an example embodiment of telco gateway 106 of third party call control and content insertion system 100. Telco gateway 106 comprises one or more processing unit(s) 250 adapted to execute computer software instructions of operating system 264 and other computer software as required to provide the functionality described herein. For example and not limitation, processing unit(s) 250 may include microprocessors or other similar components. Each processing unit 250 is connected to bus 252 for the bi-directional communication of address, data and control signals with bus 252 via bi-directional communication paths 254. Bus 252 includes a plurality of address, data and control electrical signal paths as appropriate to communicate address, data and control electrical signals between the various components of telco gateway 106.

Telco gateway 106 further comprises memory 256, including non-volatile memory 258 and volatile memory 260. Memory 256 is communicatively connected to bus 252 through one or more bi-directional communication paths 262 for the bi-directional communication of computer software instructions, addresses, data and control signals with bus 252 and other components connected to bus 252. Non-volatile memory 258 generally stores information and/or data that will not be lost when electrical power to non-volatile memory 258 is removed. Examples of non-volatile memory include, without limitation, flash random access memory devices, battery backed up random access devices, read only memory devices, programmable read only memory devices, electrically programmable read only memory devices, magnetic disks, optical disks, and other similar or non-similar devices available now or in the future. Volatile memory 260 typically stores information and/or data for a temporary period of time, as such information and/or data that will be lost when electrical power is no longer supplied to volatile memory 260. Examples of volatile memory include, but are not limited to, non-battery backed up random access memory devices.

In accordance with at least one example embodiment, non-volatile memory 258 stores a plurality of computer software instructions of operating system 264 that, when delivered to and executed by processing unit 250, enable processing unit 250 and other website server components to perform various actions and provide the basic functionality necessary to implement the methods described herein. Non-volatile memory 258 also stores computer software instructions of call control module 266, media module 268, and content module 270, which are communicated to and executed by processing unit 250. Telco gateway 106 beings execution of the computer software instructions of call control module 266, media module 268, and content module 270 when telco gateway 106 receives a message from the website server 108 instructing telco gateway 106 to establish a communication session between telco gateway 106 and calling and called party communication devices 102, 104.

Generally, call control module 266 directs the overall management of the telco gateway's set up of calls for a communication session between telco gateway 106, calling party communication device 102, and called party communication device 104. When the computer software instructions of call control module 266 are executed by processing unit 250 of telco gateway 106, telco gateway 106 performs activities such as, for example and not limitation: establishing a call with calling party communication device 102; commencing the communication of, and communicating, played back content to calling party communication device 102; initiating a call with called party communication device 102; blocking alert notifications received from called party communication network 122 while waiting for called party communication device 104 to answer; monitoring the amount of time passing while waiting for called party communication device 104 to answer and ending the call to called party communication device 104 if more than a pre-determined amount of time passes; detecting an answer of the call to called party communication device 104; terminating the communication of played back content to calling party communication device 102 upon detecting an answer of the call to called party communication device 104; and, connecting the calls with calling party communication device 102 and called party communication device 104 upon detecting an answer of the call to called party communication device 104.

Media module 268 is generally responsible for the telco gateway's playback of content identified to media module 268 by content module 270. When the computer software instructions of media module 268 are executed by processing unit 250 of telco gateway 106, telco gateway 106 performs tasks including, but not limited to: receiving a message from call control module 266 to initiate content playback; receiving a message from content module 270 identifying a media resource to provide content and the particular content to be played back; establishing a communication path with the media resource; retrieving content from the media resource via the established communication path; initiating playback of the content and insertion of the content into the call with the calling party communication device; receiving a message from call control module 266 to cease content playback; and, stopping playback of the content.

In general, content module 270 determines what content should be played back and informs media module 268 of such determination. When the computer software instructions of content module 270 are executed by processing unit 250 of telco gateway 106, telco gateway 106 performs activities such as, for example and not limitation: receiving a message including identifiers for calling and called party communication devices 102, 104; determining what content should be selected for playback and where the content has been previously stored; and, producing and communicating a message to media module 268 identifying the media resource and content that should be played back to calling party communication device 102. Content module 270 may determine what content should be played back based upon a variety of criteria. For example, if content module 270 ascertains that the identifier for called party communication device 104 indicates that called party communication device 104 belongs to a business, content module 270 may determine that content constituting targeted advertisements for the business should be played back. In further example, if calling party communication device 102 is capable of receiving text messages, content module 270 may determine that content constituting relevant textual information should be played back. In still further example, if calling party communication device 102 comprises a video phone, personal communication device, personal digital assistant, or other device capable of displaying pictures, images, or videos, content module 270 may determine that content constituting video should be played back.

In addition, non-volatile memory 258 stores a database including content for playback and/or links to content for playback that is stored at other locations. Further, non-volatile memory 258 stores non-volatile data 274 that is used by processing unit 250 during execution of the computer software instructions of operating system 264, call control module 266, media module 268, and content module 270.

Volatile memory 260 stores volatile data 276 that is created and/or used by operating system 264, call control module 266, media module 268, and content module 270 during execution. Such volatile data 276 may include, for example and not limitation: identifiers for calling and called party communication devices 102, 104 received from website server 108; messages received from website server 108; messages generated by call control module 266, media module 268, or content module 270; temporarily stored identifiers for media resources and content; temporarily stored content; and, intermediate data produced by execution of operating system 264, call control module 266, media module 268, or content module 270.

Telco gateway 106 may also comprise communication interfaces 280, 282 that connect to bus 252 for the bi-directional communication of address, data and control signals via respective communication paths 284, 286. Communication interface 280 may connect telco gateway 106 to website server 108 through communication link 110 for the bi-directional communication of messages, information, data, and/or signals therebetween. Communication interface 282 connects telco gateway 106 to public communication network 112 for the bi-directional communication of messages, information, data, and/or signals with calling party communication devices 102 and called party communication devices 104.

Telco gateway 106 may additionally comprise display interface 290 connected to bus 252 via communication path 292 for the bi-directional communication of addresses, data and/or control signals with bus 252 and various components connected to bus 252. Display device 294 is connected to display interface 290 via communication path 296 for the receipt and display of video or image signals received from display interface 290. Similarly, input device interface 300 is connected to bus 252 via communication path 302 for the bi-directional communication of addresses, data and/or control signals with bus 252 and various components connected to bus 252. Keyboard 304 and pointing device 306 are, respectively, connected to input device interface 300 via respective communication paths 308, 310 for the receipt of input from an administrator of telco gateway 106 and for the communication of data representative of such input to input device interface 300. Power supply 316 is connected to bus 252 through electrical signal path 318 and supplies electrical energy to bus 252 and to components connected to bus 252, which is necessary for their operation.

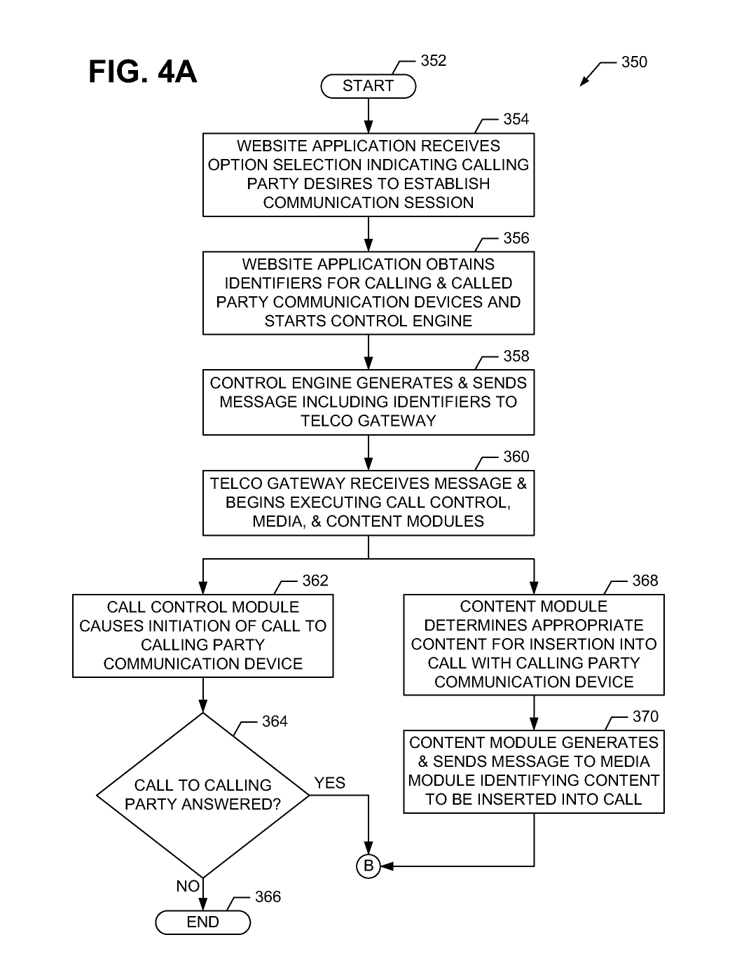

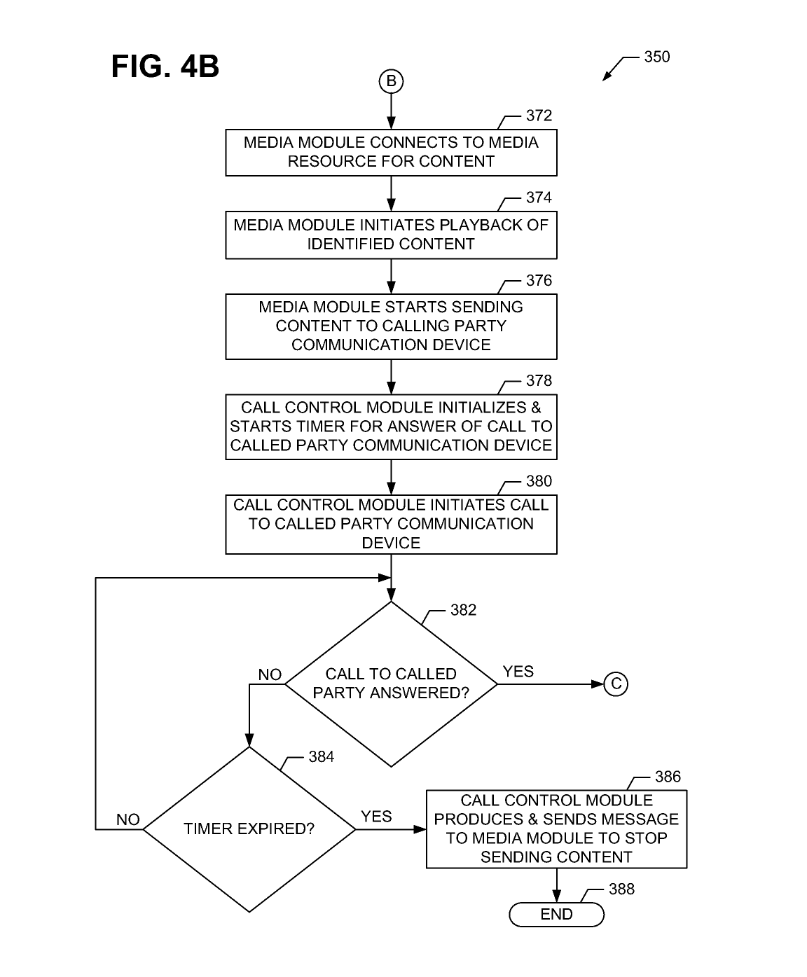

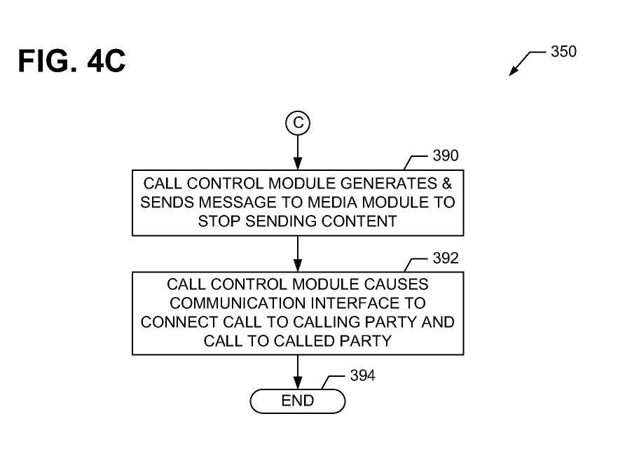

FIGS. 4A and 4B display a flowchart representation of an example embodiment of operating method 350 of third party call control and content insertion system 100. Operating method 350 (also referred to herein as “method 350”) may be implemented by website server 108 through execution of website application 166 and control engine 168 by processing unit 150, and by telco gateway 106 through execution of the call control module 266, media module 268, and content modules 270 by processing unit 250. Through operation in accordance with method 350, website server 108 and telco gateway 106 interact to establish a communication session between telco gateway 106, calling party communication device 102, and called party communication device 104, and to playback and provide content to calling party communication device 102 while waiting for called party communication device 104 to join the communication session.

Operation of system 100 according to an example embodiment of method 350 starts in block 352 and advances to block 354 when website application 166 (and, hence, website server 108) receives selection of an option from a web page by a calling party indicating that the calling party desires to establish a communication session with a called party. Moving forward to block 356, the website application 166 obtains identifiers associated with the calling and called party communication devices 102, 104, and causes execution of control engine 168 to begin. After receiving the identifiers from website application 166, control engine 168 generates and sends, in block 358, a message including the identifiers of calling and called party communication devices 102, 104, to telco gateway 106 directing telco gateway 106 to establish the communication session.

In response to receiving the message from control engine 168 of the website server 108 in block 360, telco gateway 106 initiates execution of call control module 266, media module 268, and content module 270 and routes the message to call control module 266 and content module 270 which operate on the message in parallel. Call control module 266 causes communication interface 282 of telco gateway 106, using the received identifier for calling party communication device 102 to initiate a call to calling party communication device 102 in block 362. Then, in block 364, call control module 266 interacts with communication interface 282 to determine whether the call has been answered by the calling party. If the call has not been answered after the passage of a suitable period of time, call control module 266 causes telco gateway 106 to stop further operation according to method 350 in block 366. Alternatively, if call control module 266 determines in block 364 that the call has been answered, operation of system 100 advances to block 372 described below.

While call control module 266 is attempting to establish a call with calling party communication device 102 as described above, content module 270 determines the appropriate content for insertion into the call with calling party communication device 102 in block 368. Content module 270 may utilize a variety of factors in determining which content is appropriate for insertion into the call, may select content from a list of content in a pre-determined order, or may select content on a random basis. For example, content module 270 may use the identifier for called party communication device 104 to ascertain whether the called party is a business and, if so, select content comprising an advertisement enumerating the various products and/or services provided to customers by the business. If content module 270 determines that the called party is not a business, then content module 270 might select content comprising a weather forecast, traffic report, or advertisement of local events relevant to locale in which calling or called party communication device 102, 104 is then present. Once content module 270 has determined what content should be inserted into the call, in block 370, content module 270 generates and sends a message to media module 268 identifying the content for insertion into the call.

At block 372 and upon receiving identification of the content for insertion into the call, media module 268 establishes a connection, or communication path, with the media resource from which the identified content is to be obtained. The media resource may comprise database 272 or may comprise a content source outside of system 100. Regardless of the location of the media resource, media module 268 initiates playback of the identified content in block 374 and starts sending the content to calling party communication device 102 by insertion into the call therewith in block 376.

System 100 continues operation according to method 350 in block 378 where call control module 266 initializes and starts a countdown timer for answer of a call to called party communication device 104. Then, in block 380, call control module 266 directs communication interface 282 of telco gateway 106 to initiate a call to called party communication device 104 using the identifier for called party communication device 104 received from control engine 168 of website server 108. Next, in block 382 and through interaction with communication interface 282, call control module 266 ascertains whether the call to called party communication device 104 has been answered.

If, in block 382, call control module 266 ascertains that the call has not been answered, call control module 266 advances to block 384 where call control module 266 decides whether the countdown timer has expired or not. If the countdown timer has not expired, call control module 266 returns to block 382 to again check for answer of the call placed to called party communication device 104. However, if the countdown timer (and, hence, the timeout period) has expired, it is presumed that called party is unavailable to answer the call to called party communication device 104. In such case, call control module 266 moves ahead to block 386 where call control module 266 produces and communicates a message to media module 268 causing media module 268 to stop playback of the content. Then, in block 388, operation of system 100 ends.

If, in block 382, call control module 266 ascertains that the call to called party communication device 104 has been answered, call control module 266 generates and sends a message so informing media module 268 and media module 268 stops playback of the content in block 390. Call control module 266 then, in block 392, instructs communication interface 282 to, and communication interface 282 does, connect the call to calling party communication device 102 and the call to called party communication device 104. Operation of system 100 according to method 350 subsequently ends in block 394.

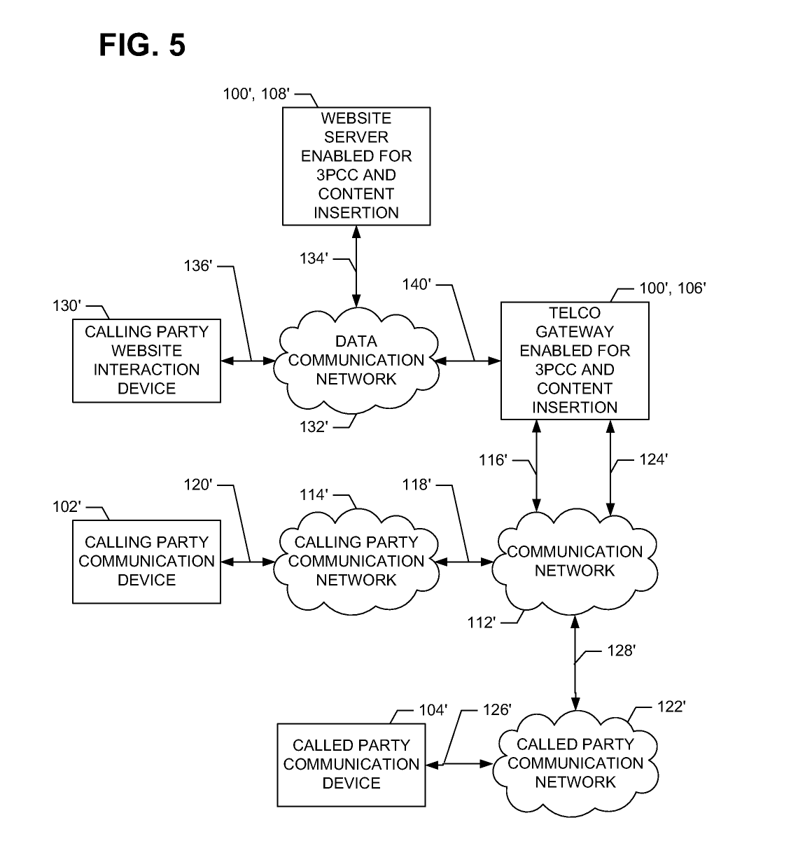

FIG. 5 displays a block diagram representation of third party call control and content insertion system 100′ and environment in accordance with an alternative embodiment of the present invention. Third party call control and content insertion system 100′ of the alternative embodiment is substantially similar in components, structure, and operating method to third party call control and content insertion system 100 with like components configured and operating in a substantially similar manner. Therefore, the following description of third party call control and content insertion system 100′ of the alternative embodiment highlights differences with the third party call control and content insertion system 100.

According to the alternative embodiment, third party call control and content insertion system 100′ includes website server 108′ that is not directly connected by a communication link to telco gateway 106′ for the bi-directional communication of information, data, and/or signals. Instead, website server 108′ is connected to data communication network 132′ and communicates information, data, and/or signals bi-directionally with telco gateway 106′ via data communication link 134′, data communication network 132′, and communication link 140′ between telco gateway 106′ and data communication network 132′.

In addition, website server 108′ is configured with website application 166′ that implements a website enabling client-side initiation of a communication session between telco gateway 106′, calling party communication device 102, and called party communication device 104. The website may comprise, for example and not limitation, a website such as that found at www.whitepages.com. During interaction with website application 166′, the calling party selects an option from the website indicating that the calling party desires to establish a communication session with calling party communication device 102′ and called party communication device 104′. In response, website application 166′ obtains identifiers for calling and called party communication devices 102′, 104′ and causes control engine 168′ to generate and communicate a message including the identifiers to telco gateway 106′ through communication links 134′, 140′ and data communication network 132′. Once telco gateway 106′ receives the message, telco gateway 106′ operates as described above with reference to method 350 to establish a communication session between telco gateway 106′, calling party communication device 102′, and called party communication device 104′, and provide content to calling party communication device 102′ while waiting on an answer of called party communication device 104′.

The flow chart of FIGS. 4A and 4B show the architecture, functionality, and operation of a possible implementation of systems and methods of third party call control and content insertion software. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in FIG. 4A may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a non exhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Although the present disclosure has been described in detail, it should be understood that various changes, substitutions and alterations can be made thereto without departing from the spirit and scope of the disclosure as defined by the appended claims.

1. A method comprising:
receiving input indicating a calling party's desire to establish a communication session with a called party between a calling party communication device and a called party communication device;
establishing a call with the calling party communication device;
initiating a call to the called party communication device;
communicating content to the calling party communication device while waiting on an answer of the call to the called party communication device; and
connecting the call with the calling party communication device and the call to the called party communication device after answer of the call to the called party communication device.

2. The method of claim 1, wherein the calling party communication device is adapted to receive only audible content.

3. The method of claim 2, wherein the content comprises an audible advertisement.

4. The method of claim 2, wherein the content comprises a news story.

5. The method of claim 2, wherein the content comprises a weather alert.

6. The method of claim 2, wherein the content comprises information pertaining to traffic.

7. The method of claim 1, wherein the calling party communication device is adapted to receive audible and viewable content.

8. The method of claim 1, wherein the content comprises a viewable advertisement.

9. The method of claim 7, wherein the content comprises a viewable music video.

10. The method of claim 7, wherein the content comprises a viewable weather map.

11. A method comprising:
receiving input provided via interaction with a website indicating a calling party's desire to establish a communication session with a called party between a calling party communication device and a called party communication device;
establishing a call with the calling party communication device;
initiating a call to the called party communication device;
selecting content for communication to the calling party communication device; and
connecting the call with the calling party communication device and the call to the called party communication device after answer of the call to the called party communication device.

12. The method of claim 11, wherein selecting further comprises identifying content for communication based at least in part on a characteristic of a called party associated with the called party communication device.

13. The method of claim 11, wherein selecting further comprises identifying content for communication based at least in part on the location of the called party communication device.

14. The method of claim 11, wherein selecting further comprises identifying content for communication based at least in part on a characteristic of the calling party communication device.

15. The method of claim 11, wherein selecting further comprises identifying content for communication based at least in part on profile information previously stored and associated with the calling party.

16. The method of claim 11, wherein selecting further comprises identifying content for communication based at least in part on demographic information relevant to the calling party.

17. An apparatus comprising:
a device configured for establishing a call from a calling party communication device to a called party communication device in response to receiving direction via a website to establish a communication session involving the calling party communication device and the called party communication device, said device being further configured to communicate content to the calling party communication device while waiting on the called party communication device to answer.

18. The apparatus of claim 17, wherein the called party communication device is associated with a called party and said device is further configured to select the content based at least in part on a characteristic of the called party.

19. The apparatus of claim 17, wherein the called party communication device is associated with a geographical location and said device is further configured to select the content based at least in part on said geographical location.

20. The apparatus of claim 17, wherein the calling party communication device is associated with a called party and with information identifying content preferred by the calling party, and said device is further configured to select the content based at least in part on the information.
